(19) United States
(12) Patent Application Publication
(10) Pub. No.: US 2015/0343621 A1
(43) Pub. Date: Dec. 3, 2015

(54) WRENCH EASILY ADJUSTABLE IN TORQUE

(71) Applicant: KABO TOOL COMPANY, Taichung City (TW)

(72) Inventor: Chih-Ching HSIEH, Taichung City (TW)

(21) Appl. No.: 14/667,591

(22) Filed: Mar. 24, 2015

(30) Foreign Application Priority Data
Jun. 3, 2014 (TW) 103119249

(51) Int. Cl. B25B 23/142

(52) U.S. Cl. CPC B25B 23/1427

(57) ABSTRACT

A wrench includes: a main body having a tubular body and a head section, a rear end of the tubular body being formed with a first screwed section; a collapse mechanism disposed between the tubular body and the head section; a central rod disposed in the tubular body and formed with a first threaded section; a torque adjustment mechanism including at least one elastic member and an adjustment member, the adjustment member being formed with a second threaded section screwed with the first threaded section of the central rod; and a handle having a second screwed section screwed with the first screwed section of the tubular body. The handle is connected with the adjustment member. When rotating the handle, the adjustment is also rotated so that the torque of the wrench is easily adjustable.

### BACKGROUND OF THE INVENTION

1. Field of the Invention

The present invention relates generally to a wrench, and more particularly to a wrench easily adjustable in torque.

2. Description of the Related Art

A torque wrench has the function of setting operation torque. When the wrench is used to wrench a threaded member and the wrenching force reaches a set torque, the wrench will collapse to remind an operator to stop wrenching.

FIG. 1 shows a conventional torque wrench 70. The torque wrench 70 has a head section 72. A front end of the head section 72 has a drive end 74 for fitting with a socket or a threaded member. The torque wrench 70 further has a tubular body 76. A holding sleeve 77 is disposed around the outer circumference of a rear end of the tubular body 76 for a user to hold to wrench the wrench 70, whereby the drive end 74 can wrench the threaded member. The front end of the tubular body 76 is connected with the head section 72. The torque wrench 70 further has a torque adjustment mechanism including an elastic member (not shown) and an adjustment member 78. The adjustment member 78 is positioned at a rear end of the tubular body 76. A collapse mechanism 79 is disposed between the tubular body and the head section. When the wrench 70 is used to wrench a threaded member and the wrenching force reaches a set torque, the wrench will collapse to remind an operator to stop wrenching. By means of rotating the adjustment member 78, the elastic energy of the elastic member can be changed to reset the torque of the torque wrench.

The above torque wrench has some shortcomings in the adjustment member for adjusting the torque of the wrench. For example, in the torque wrench, the elastic force of the elastic member is increased or decreased by means of rotating the adjustment member so as to adjust the torque value. However, the adjustment member is received in the tubular body so that the radius of the adjustment member is relatively small. In this case, it is uneasy for a user to rotate the adjustment member so as to adjust the torque value of the wrench.

Moreover, when a user adjusts the torque of the wrench to a higher value, the adjustment member compresses the elastic member and is gradually retracted into the tubular body. As a result, the area provided by the adjustment member for the user to rotate is minified. In this case, it is even more difficult for the user to rotate the adjustment member. Therefore, the difficulty in adjusting the torque is increased.

It is therefore tried by the applicant to provide a wrench, which is easily adjustable in torque to solve the above problems.

### SUMMARY OF THE INVENTION

It is therefore a primary object of the present invention to provide a wrench, which enables a user to more easily adjust the torque value of the wrench.

To achieve the above and other objects, the wrench easily adjustable in torque of the present invention includes:

a main body having a tubular body and a head section, the head section being positioned at a front end of the tubular body;

a collapse mechanism disposed between the tubular body and the head section, when the wrenching force of the wrench reaches a set torque, the collapse mechanism is collapsible;

a central rod disposed in the tubular body of the main body, a front end of the central rod being pivotally connected with the head section;

a torque adjustment mechanism including at least one elastic member and an adjustment member, a front end of the adjustment member being fitted with a rear end of the central rod and axially movable along the central rod, the elastic member being mounted in the tubular body, two ends of the elastic member respectively abutting against an inner side of the tubular body and the adjustment member; and

a handle, a front end of the handle being fitted with a rear end of the tubular body and movable in the axial direction of the tubular body, the handle being connected with the adjustment member.

An outer circumference of a rear end of the tubular body is formed with a thread as a first screwed section. A front end of the handle is inward recessed to forma screwed hole. The thread of the screwed hole serves as a second screwed section. The second screwed section of the handle is screwed with the first screwed section of the tubular body.

A rear end of the central rod is formed with a thread as a first threaded section. A front end of the adjustment member is formed with a threaded hole. The thread of the threaded hole serves as a second threaded section. The second threaded section of the adjustment member is screwed with the first threaded section of the central rod.

The pitches of the first screwed section of the tubular body, the second screwed section of the handle, the first threaded section of the central rod and the second threaded section of the adjustment member are equal to each other.

Accordingly, the handle is fitted with and connected to the adjustment member. When rotating the handle, the adjustment is also rotated. The handle has a radius larger than that of the adjustment member. According to torque principle, the longer the moment arm is, the smaller the required effort is. Therefore, a user can more easily rotate the handle to save strength and the torque of the wrench can be more easily adjusted.

Furthermore, the handle is fitted on the outer circumference of the tubular body. Therefore, when most of the volume of the adjustment member is retracted into the tubular body, the handle can still provide a complete rotational area for a user to conveniently adjust the torque of the wrench.

The present invention can be best understood through the following description and accompanying drawings, wherein:

### BRIEF DESCRIPTION OF THE DRAWINGS

FIG. 1 is a perspective view of a conventional torque wrench;

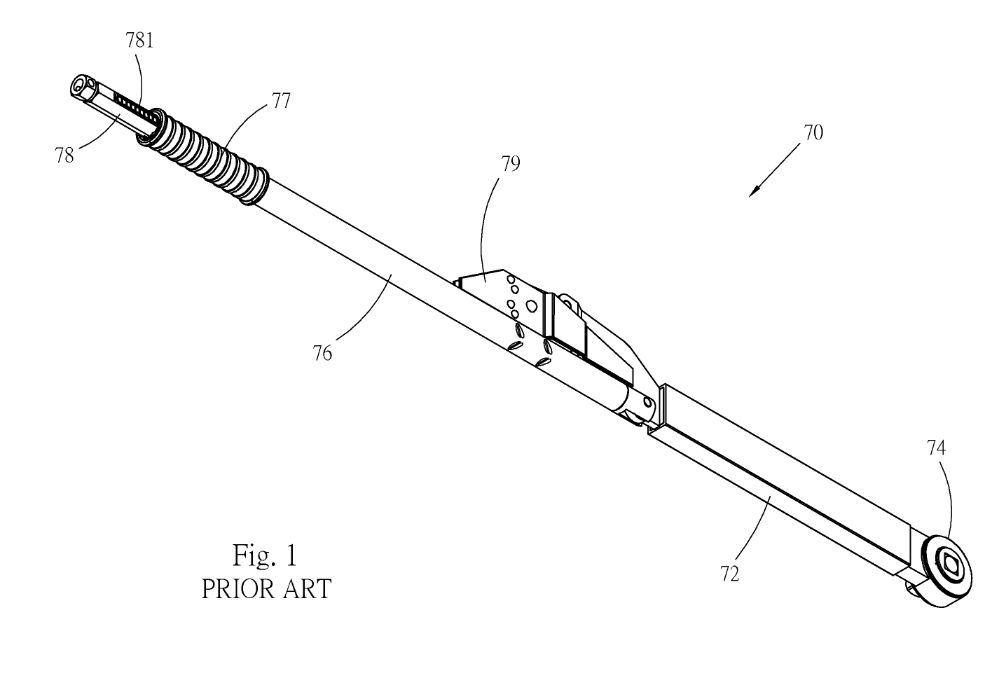

FIG. 2 is a perspective view of a first embodiment of the present invention;

FIG. 3 is a perspective exploded view of the first embodiment of the present invention according to FIG. 2;

FIG. 4 is a longitudinal sectional view according to FIG. 2;

FIG. 5 is an enlarged view of a part of FIG. 4;

FIG. 6 is an enlarged view of another part of FIG. 4;

FIG. 7 is a longitudinal sectional view showing that the wrench of the present invention is in a collapse state;

FIG. 8 is a sectional view of the torque adjustment mechanism of a second embodiment of the wrench of the present invention; and

FIG. 9 is a sectional view of the torque adjustment mechanism of a third embodiment of the wrench of the present invention.

### DETAILED DESCRIPTION OF THE PREFERRED EMBODIMENTS

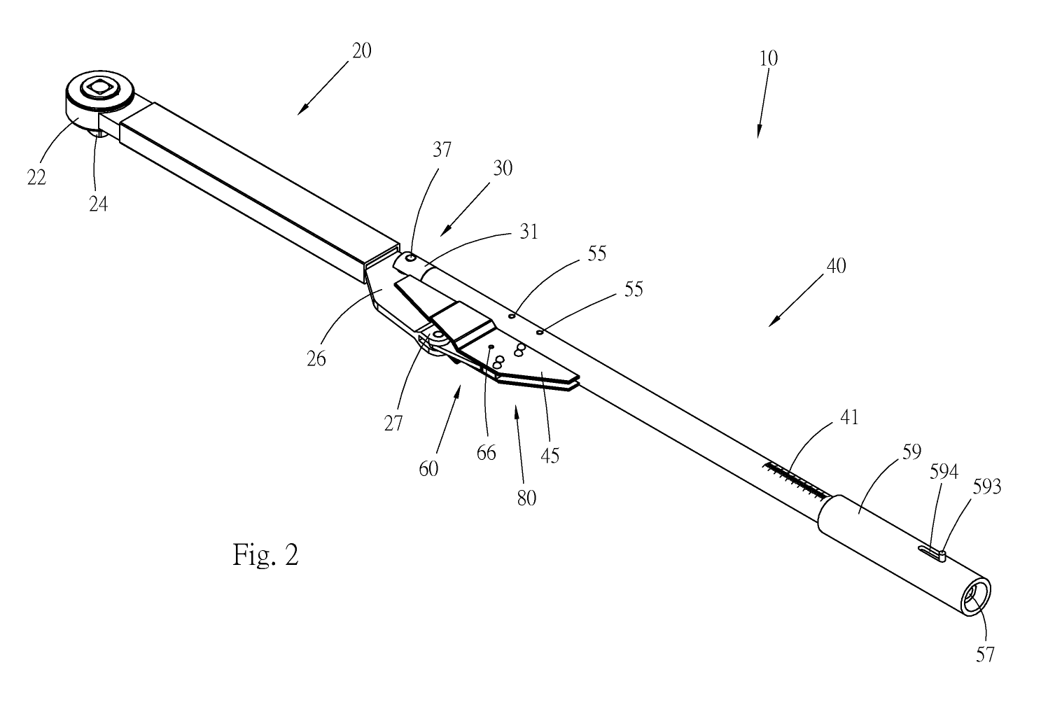

Please refer to FIGS. 2 to 4. According to a first embodiment, the wrench 10 easily adjustable in torque of the present invention includes a head section 20 and a drive end 22 disposed at a front end of the head section 20. In this embodiment, the drive end is a ratchet structure having a ratchet 221. The ratchet 221 is formed with a quadrangular fitting hole 222. An insertion column 24 is elastically locatably inserted in the fitting hole 222. The insertion column 24 of the drive end 22 is insertable into a socket (not shown). The socket is fitted onto a threaded member for wrenching the same. The form of the drive end 22 is not limited to the form of this embodiment. A first pivoted end 25 is disposed at a rear end of the head section 20. The head section further has a branch bar 26 extending from one end of the head section 20 to one side thereof. A rear end of the branch bar 26 is formed with a second pivoted end 27 of the head section 20. The second pivoted end 27 has the form of two lugs. The first and second pivoted ends are spaced from each other.

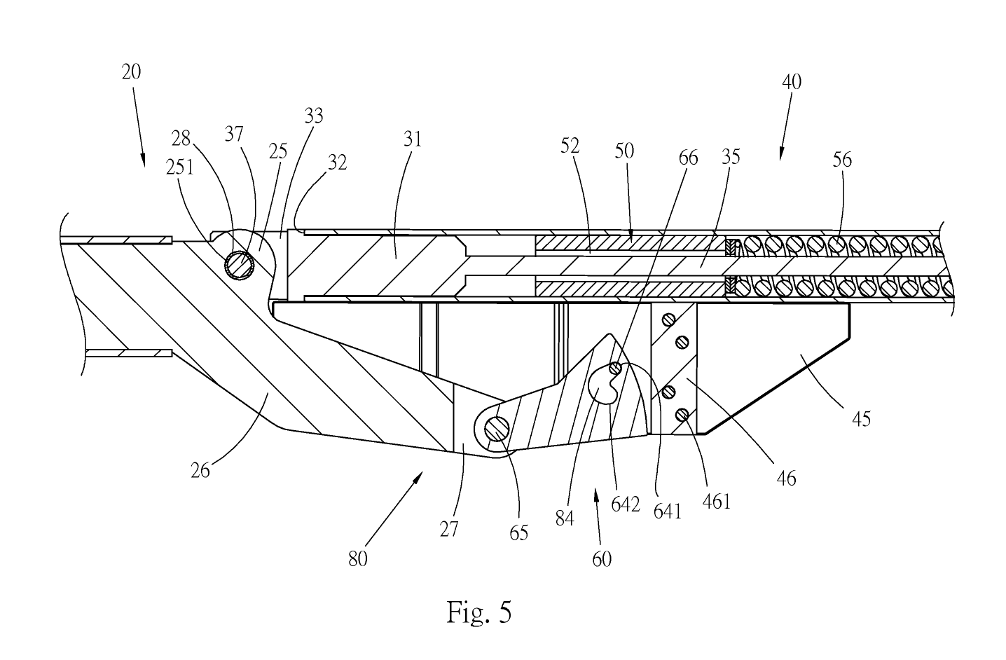

The wrench 10 of the present invention further includes a central rod 30. The central rod 30 has a large-diameter section 31 at a front end and a slender rod section 35 fixedly connected with a rear end of the large-diameter section 31. The circumference of the large-diameter section 31 is formed with a shoulder section 32. A front end of the large-diameter section 31 is formed with two lugs 33 spaced from each other by a certain distance. The two lugs define therebetween a recess 331. A through hole 34 is formed through the two lugs 33. The circumference of a rear end of the slender rod section 35 is formed with a thread as a first threaded section 36. The front end of the central rod 30 is pivotally connected with the first pivoted end 25 of the head section 20. To speak more specifically, the first pivoted end 25 is positioned in the recess 331 between the two lugs 33 of the large-diameter section 31. The first pivoted end 25 and the two lugs 33 together form a sandwich pivot structure. The first pivoted end 25 serves as a middle section positioned between the two lugs 33. A first pivot pin 37 is passed through the through hole 34 of the two lugs 33 and a pivot hole 251 of the first pivoted end 25, whereby the head section 20 and the central rod 30 are pivotally connected with each other and swingable relative to each other. Referring to FIG. 5, the pivot hole 251 of the first pivoted end 25 has a diameter larger than that of the through hole 34 of the central rod 30. A relatively soft collar such as a copper collar 28 is mounted in the pivot hole 251. The pivot pin 37 is fitted in the copper collar 28. Two ends of the pivot pin 37 are tightened with the wall of the through hole 34. By means of such structural design, the pivotal gap between the first pivoted end 25 and the large-diameter section 31 can be minified. On the other hand, when the central rod 30 is angularly moved relative to the head section 20, the pivot pin 37 is rotated along with the central rod 30. The copper collar 28 serves as a lubricant medium between the wall of the pivot hole 251 and the pivot pin 37 to enhance the smoothness of relative rotation between the large-diameter section 31 and the first pivoted end 25. This can avoid wear of the pivoted sections of the large-diameter section 31 and the first pivoted end 25 and ensure a true torque value of the wrench 10. In this case, the precision of the wrench 10 will not deteriorate due to long-term use.

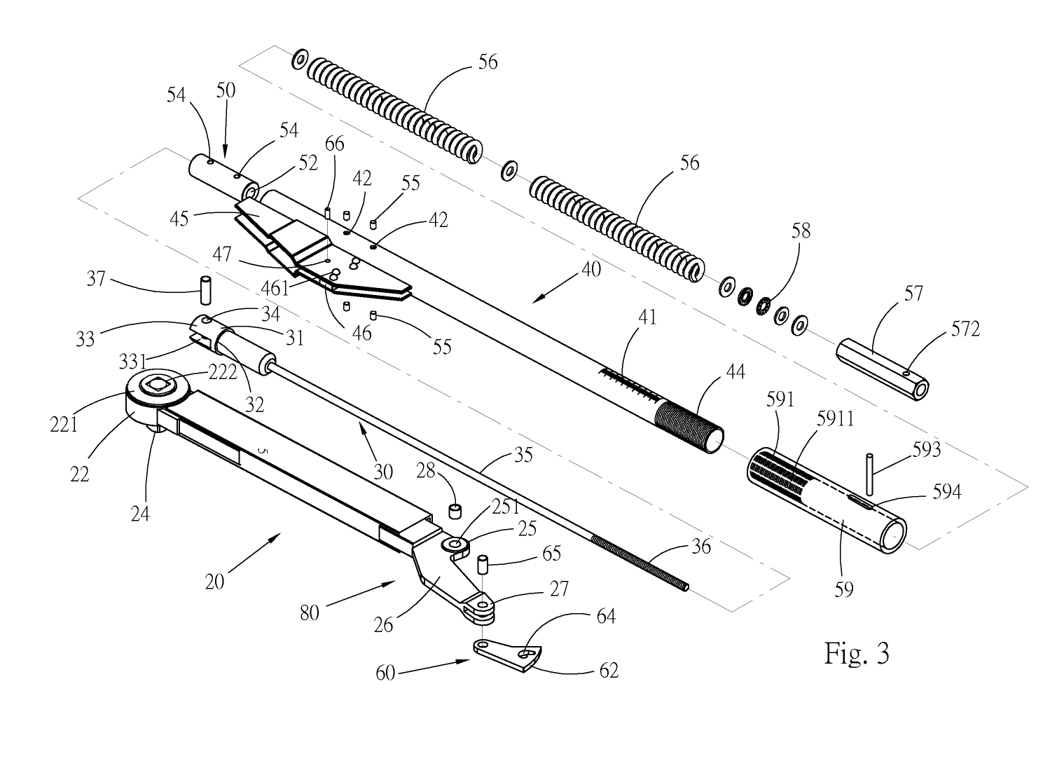

The wrench 10 of the present invention further includes a tubular body 40 including a casing 45 fixedly disposed on one side of the tubular body 40. The outer circumference of a rear end of the tubular body 40 is formed with a thread as a first screwed section 44. The outer circumference of a rear end of the tubular body 40 is further formed with a scale 41 in adjacency to a front end of the first screwed section 44 for a user to read the torque value of the wrench 10. The tubular body 40 is fitted around the central rod 30, whereby the tubular body 40 and the central rod 30 are slidable relative to each other. The front end of the tubular body 40 is fitted on the large-diameter section 31 of the central rod 30. The slender rod section 35 is positioned in the tubular body 40 and extends to the rear end of the tubular body 40. The casing 45 is composed of two plate bodies up and down side by side arranged. The casing 45 defines an internal receiving space. A block body 46 is fixed in the casing 45 by several rivets 461 as a spacer for keeping the two plate bodies spaced from each other by a fixed distance. Please refer to FIG. 3, the circumference of the tubular body 40 is formed with two radial pinholes 42 passing through the tubular body 40 between a top edge and a bottom edge thereof. A second pinhole 47 is formed through the casing 45 between a top face and a bottom face thereof.

The wrench 10 of the present invention further includes a torque adjustment mechanism mounted in the tubular body 40. The torque adjustment mechanism includes a fixed block 50, at least one elastic member 56 (two elastic members for example) and an adjustment member 57.

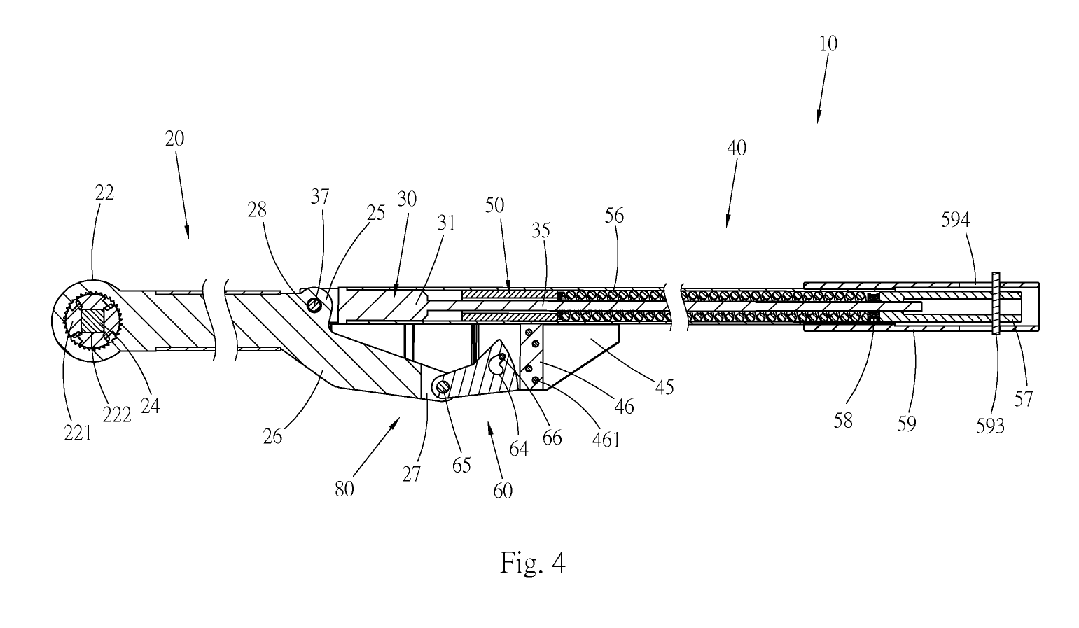

The fixed block 50 is a hollow cylindrical body formed with an axial internal passage 52. Two insertion holes 54 are radially formed through the fixed block 50. The fixed block 50 is mounted in the tubular body 40 with the two insertion holes 54 respectively aligned with the two pinholes 42. Four pin bodies 55 are respectively inserted in two ends of the two pinholes 42 of the tubular body 40 and two ends of the two insertion holes 54 of the fixed block 50 to fix the fixed block 50 with the tubular body 40. The pin bodies 55 are not passed through the fixed block 50. The slender rod section 35 of the central rod 30 is passed through the passage 52 of the fixed block 50, as shown in FIGS. 4 and 5.

In this embodiment, the elastic member 56 is a compression spring mounted in the tubular body 40. Two ends of the elastic member 56 respectively abut against the fixed block 50 and the adjustment member 57. In practice, the elastic member 56 abuts against the adjustment member 57 via a bearing 58 to reduce the friction between the elastic member 56 and the adjustment member 57.

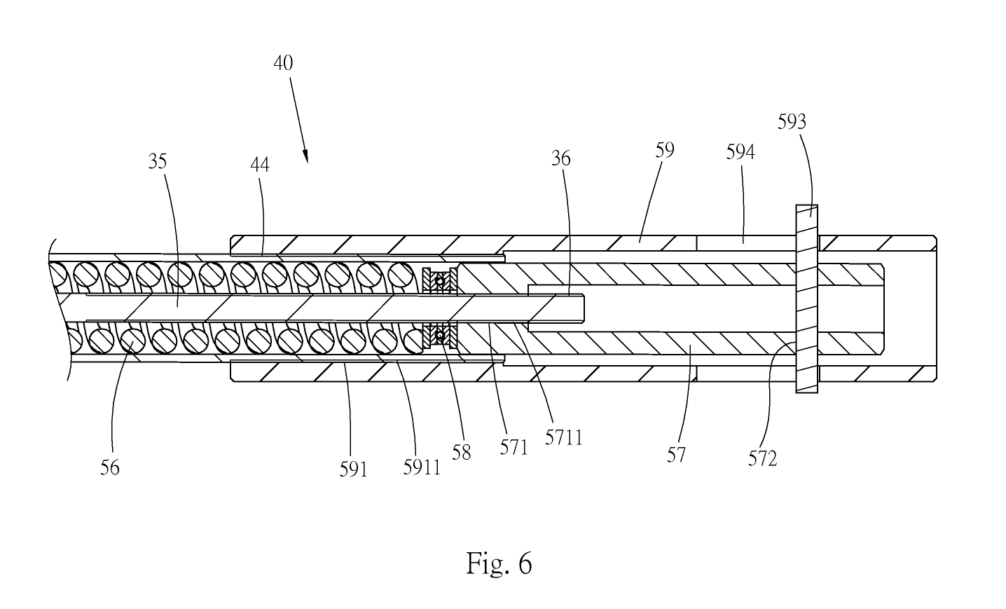

Please now refer to FIGS. 3 and 6. The adjustment member 57 has the form of a rod. The adjustment member 57 has a perforation 572 radially passing through the adjustment member. The interior of the adjustment member 57 is formed with an axial threaded hole 571. The thread of the threaded hole 571 serves as a second threaded section 5711. The second threaded section 5711 of the adjustment member is screwed with the first threaded section 36 of the slender rod section 35 of the central rod 30. Most of the volume of the adjustment member 57 protrudes from the rear end of the tubular body 40. When rotating the adjustment member 57, the adjustment member 57 is moved in the axial direction of the central rod 30.

The wrench 10 of the present invention further includes a handle 59. A front end of the handle 59 is inward recessed to forma screwed hole 591. The thread of the screwed hole 591 serves as a second screwed section 5911. The second screwed section 5911 of the handle 59 is screwed with the first screwed section 44 of the tubular body 40. A slot 594 is radially formed through the handle 59. The lengthwise direction of the slot 594 extends along the longitudinal direction of the handle 59. The slot 594 is aligned with the perforation 572 of the adjustment member 57. A connecting member 593 such as a pin member is passed through the slot 594 of the handle 59 and the perforation 572 of the adjustment member 57. In this embodiment, the connecting member 593 is fixed in the perforation 572 of the adjustment member.

The pitches of the first screwed section 44 of the tubular body 40, the second screwed section 5911 of the handle 59, the first threaded section 36 of the central rod 30 and the second threaded section 5711 of the adjustment member 57 are the same.

The handle is connected with the adjustment member by the connecting member 593, whereby when the handle 59 is rotated, the adjustment member 57 is synchronously driven and rotated to move in the axial direction of the central rod 30 so as to increase or decrease the elastic force of the elastic member 56 and change the torque of the wrench 10.

The wrench 10 of the present invention further includes a detent member 60 having a front end and a rear end. The rear end of the detent member 60 is an arched end 62. An arched locating slot 64 is formed on the body of the detent member 60. The detent member 60 is received in the casing 45. The front end of the detent member 60 is pivotally connected with the second pivoted end 27 of the branch bar 26 via a second pivot pin 65, whereby the detent member 60 is angularly movable around the pivot pin 65. A restriction pin 66, which is an insertion pin is inserted in the pinhole 47 of the casing 45 and passed through the locating slot 64 of the detent member 60. When necessary, the arched end 62 of the detent member 60 can contact the block body 46 of the casing 45 to provide stopping effect. The branch bar 26, the casing 45, the detent member 60 and the restriction pin 66 in the embodiment serve as a collapse mechanism 80, the collapse mechanism is collapsible.

In a normal state, as shown in FIGS. 4 and 5, the tubular body 40 is substantially parallel to the head section 20. The elastic force of the elastic member 56 is applied to the tubular body 40 via the fixed block 50 to push and slide the tubular body 40 forward, whereby the front end of the tubular body 40 touches the shoulder section 32 of the large-diameter section 31 of the central rod 30 and is located. At this time, the detent member 60 of the collapse mechanism 80 is positioned in a first angular position and the restriction pin 66 is positioned in the first end 641 of the locating slot 64.

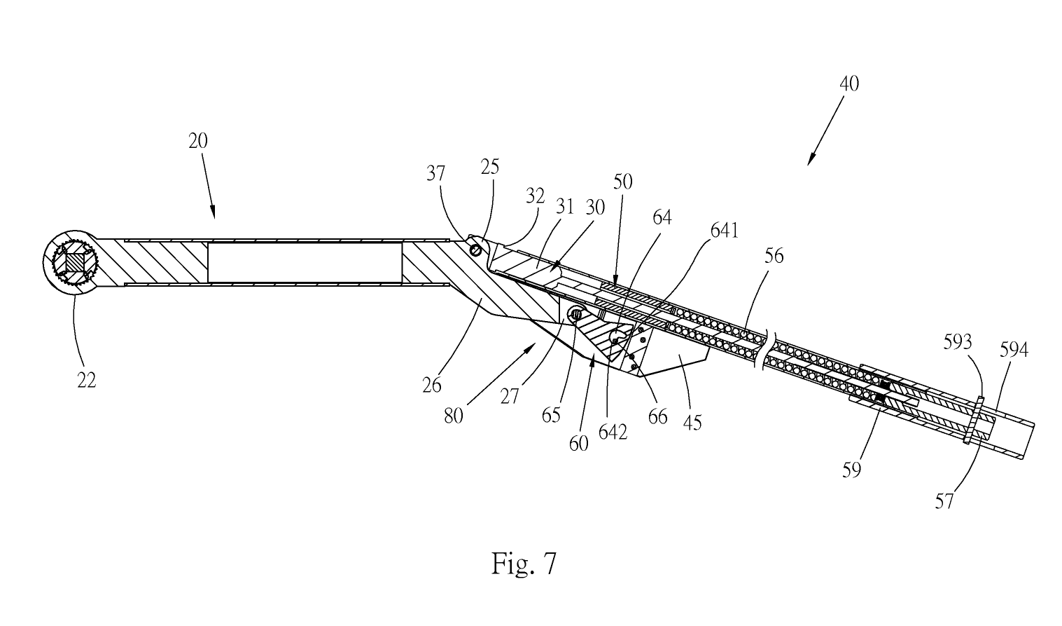

In use of the wrench 10, the drive end 22 is connected with a threaded member and the wrench 10 is rotated to wrench the threaded member. During the wrenching operation, the tubular body 40 will be moved rearward and the front end of the tubular body 40 will leave the shoulder section 32 of the large-diameter section 31. The fixed block 50 is moved along with the tubular body 40 to compress the elastic member 56. The handle 59 connected with the tubular body 40 is moved along with the tubular body. The tubular body 40 and the handle 59 are slid relative to the central rod 30 and the adjustment member 57. The slot 594 prevents the tubular body and the handle from being stopped by the connecting member 593 during the sliding process. The detent member 60 is angularly moved within the casing 45. When the applied force exceeds the set torque of the wrench, the collapse mechanism 80 of the wrench is in a collapse state as shown in FIG. 7 to remind a user to stop wrenching. At this time, the components behind the head section 20, that is, the tubular body 40, the central rod 30, the detent member 60, etc. are swung to one side around the pivot pins 37, 65 of the two pivoted ends 25, 27. The detent member 60 is angularly moved to a second angular position and the restriction pin 66 is positioned in the second end 642 of the locating slot 64. When the wrench reaches the set torque, the tubular body 40 can also abuts against the branch bar 26 as a dead end of the swinging travel of the tubular body 40.

The handle 59 of the wrench 10 of the present invention has a radius larger than that of the adjustment member 57. According to torque principle, the longer the moment arm is, the smaller the required effort is. Therefore, a user can more easily rotate the handle 59 to save strength. The handle 59 is connected with the adjustment member 57 via the connecting member 593. When rotating the handle 59, the adjustment member 57 is also rotated to adjust the torque of the wrench 10. Moreover, the pitches of the first screwed section 44 of the tubular body 40, the second screwed section 5911 of the handle 59, the first threaded section 36 of the central rod 30 and the second threaded section 5711 of the adjustment member 57 are equal to each other. Therefore, the axial moving speeds of the handle 59 and the adjustment member 57 are equal to each other so that it can be ensured that the adjustment member can be still smoothly rotated when connected with the handle, an interferer between the handle and the adjustment member will not occur.

Furthermore, the handle 59 is screwed on the outer circumference of the tubular body 40. Therefore, when the set torque of the wrench 10 is higher, the elastic member 56 is compressed by the adjustment member 57 and most of the volume of the adjustment member 57 is retracted into the tubular body 40. However, the handle 59 can still provide a complete rotational area for a user to conveniently adjust the torque of the wrench 10.

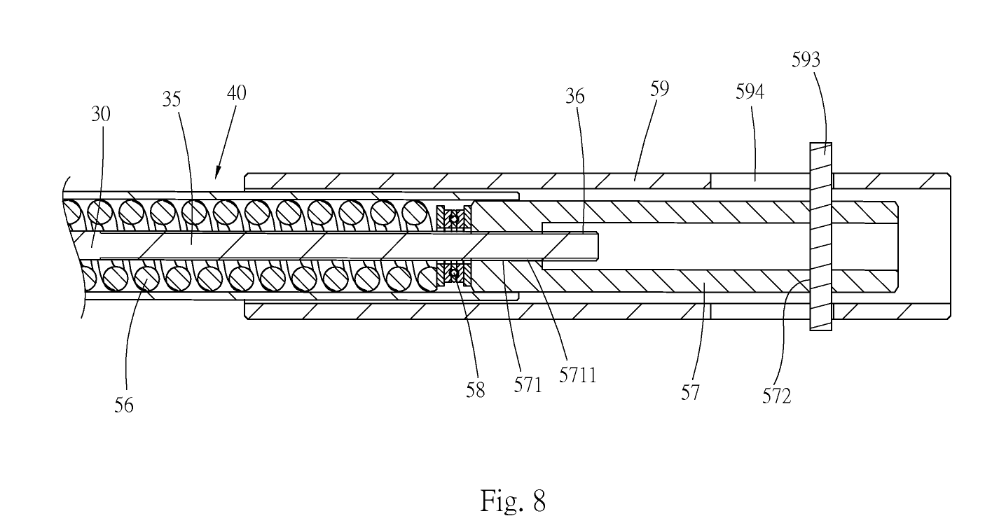

Please now refer to FIG. 8, which is a sectional view of the torque adjustment mechanism of a second embodiment of the wrench of the present invention. The same components are denoted with the same reference numerals and will not be repeatedly described. The second embodiment is characterized in that a thread is formed on a rear end of the central rod 30 as a first threaded section 36. A threaded hole 571 is formed at a front end of the adjustment member 57. The thread of the threaded hole 571 serves as a second threaded section 5711. The second threaded section 5711 of the adjustment member is screwed with the first threaded section 36 of the central rod 30.

A front end of a handle 59 is fitted with a rear end of the tubular body, the handle 59 is connected with the adjustment member 57 via a connecting member 593.

When a user rotates the handle 59, the adjustment member 57 connected with the handle 59 is synchronously rotated. Also, by means of the first threaded section 36 of the central rod 30 and the second threaded section 5711 of the adjustment member 57, the adjustment member 57 and the handle 59 can move in the axial direction of the central rod 30 to increase or decrease the elastic force of the elastic member 56 so as to adjust the torque value of the wrench 10.

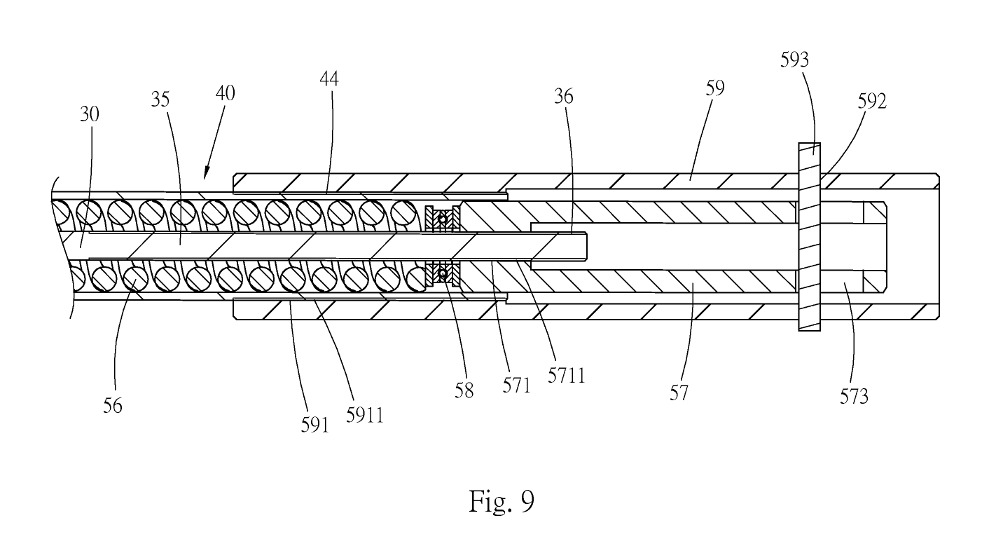

Please now refer to FIG. 9, which is a sectional view of the torque adjustment mechanism of a third embodiment of the wrench of the present invention. In this embodiment, the central rod 30, the tubular body 40, the adjustment member 57 and the handle 59 of the wrench 10 can be the structures of the first embodiment or the second embodiment. With the handle and the adjustment member of the first embodiment taken as an example, the adjustment member of the third embodiment has an elongated hole 573 axially formed on the adjustment member 57 and radially passing through the adjustment member 57. The handle 59 has a connecting hole 592 radially passing through the handle 59 in alignment with the elongated hole 573 of the adjustment member 57. The connecting member 593 is passed through and connected in the connecting hole 592 of the handle 59 and the elongated hole 573 of the adjustment member 57. In this embodiment, the connecting member 593 is fixed in the connecting hole 592.

Accordingly, when the handle 59 is rotated, the adjustment member 57 is driven to synchronously rotate with the handle 59. Also, the adjustment member is moved in the axial direction of the central rod 30 to change the compression force applied by the adjustment member 57 to the elastic member 56 so as to adjust the torque value of the wrench 10. When the wrench 10 is used to wrench a threaded member, the tubular body 40 and the handle 59 are rearward moved relative to the central rod and the adjustment member. Due to the elongated hole 573, the handle and the tubular body will not be stopped from moving rearward.

In the condition that the given structure and operation relationship of the wrench are not changed, the present invention enables a user to easily adjust the torque value of the wrench. In addition, the handle is always exposed to an outer side of the tubular body without retracting into the tubular body. Therefore, a user can conveniently rotate the adjustment member.

The above embodiments are only used to illustrate the present invention, not intended to limit the scope thereof. Many modifications of the above embodiments can be made without departing from the spirit of the present invention.

What is claimed is:

1. A wrench easily adjustable in torque, comprising:
a main body having a tubular body, an outer circumference of a rear end of the tubular body being formed with a first screwed section, a head section being positioned at a front end of the tubular body;
a collapse mechanism disposed between the tubular body and the head section, when the wrenching force of the wrench reaches a set torque, the collapse mechanism is collapsible;
a central rod, a rear end of the central rod being formed with a first threaded section, the central rod being disposed in the tubular body of the main body, the head section being pivotally connected with a front end of the central rod;
a torque adjustment mechanism including at least one elastic member and an adjustment member; a front end of the adjustment member being formed with a threaded hole, the thread of the threaded hole serving as a second threaded section, the second threaded section being screwed with the first threaded section of the central rod, whereby when the adjustment member is rotated, the adjustment member is also moved in an axial direction of the central rod; the elastic member being disposed in the tubular body, two ends of the elastic member respectively abutting against an inner side of the tubular body and the adjustment member; and
a handle, a front end of the handle being inward recessed to form a screwed hole having a second screwed section, the second screwed section being screwed with the first screwed section of the tubular body, whereby when the handle is rotated, the handle is also moved in an axial direction of the tubular body, the handle being connected with the adjustment member; and
the pitches of the first screwed section of the tubular body, the second screwed section of the handle, the first threaded section of the central rod and the second threaded section of the adjustment member being equal to each other.

2. The wrench as claimed in claim 1, further comprising a connecting member connecting the handle with the adjustment member.

3. The wrench as claimed in claim 2, wherein the handle has a slot radially formed through the handle, the lengthwise direction of the slot extending along the axial direction of the handle, the adjustment member being formed with a perforation radially formed through the adjustment member, the perforation being aligned with the slot of the handle, the connecting member being passed through the slot of the handle and the perforation of the adjustment member.

4. The wrench as claimed in claim 2, wherein the handle has a connecting hole radially formed through the handle, the adjustment member having an elongated hole axially formed on the adjustment member and radially passing through the adjustment member, the elongated hole being aligned with the connecting hole of the handle, the connecting member being passed through and connected in the connecting hole of the handle and the elongated hole of the adjustment member.

5. The wrench as claimed in claim 1, wherein a fixed block is disposed in the tubular body in abutment with one end of the elastic member.

6. The wrench as claimed in claim 1, wherein an outer circumference of a rear end of the tubular body is formed with a scale in adjacency to a front end of the handle.

7. A wrench easily adjustable in torque, comprising:
a main body having a tubular body and a head section, the head section being positioned at a front end of the tubular body;
a collapse mechanism disposed between the tubular body and the head section, when the wrenching force of the wrench reaches a set torque, the collapse mechanism is collapsible;
a central rod, a rear end of the central rod being formed with a first threaded section, the central rod being disposed in the tubular body of the main body, the head section being pivotally connected with a front end of the central rod;
a torque adjustment mechanism including at least one elastic member and an adjustment member, a front end of the adjustment member being formed with a threaded hole, the thread of the threaded hole serving as a second threaded section, the second threaded section being screwed with the first threaded section of the central rod, whereby when the adjustment member is rotated, the adjustment member is also moved in an axial direction of the central rod, the elastic member being disposed in the tubular body, two ends of the elastic member respectively abutting against an inner side of the tubular body and the adjustment member; and
a handle, a front end of the handle being fitted with a rear end of the tubular body and movable in the axial direction of the tubular body, the handle being connected with the adjustment member.

8. The wrench as claimed in claim 7, further comprising a connecting member connecting the handle with the adjustment member.

9. The wrench as claimed in claim 8, wherein the handle has a slot radially formed through the handle, the lengthwise direction of the slot extending along the axial direction of the handle, the adjustment member being formed with a perforation radially formed through the adjustment member, the perforation being aligned with the slot of the handle, the connecting member being passed through the slot of the handle and the perforation of the adjustment member.

10. The wrench as claimed in claim 8, wherein the handle has a connecting hole radially formed through the handle, the adjustment member having an elongated hole axially formed on the adjustment member and radially passing through the adjustment member, the elongated hole being aligned with the connecting hole of the handle, the connecting member being passed through and connected in the connecting hole of the handle and the elongated hole of the adjustment member.

11. The wrench as claimed in claim 7, wherein a fixed block is disposed in the tubular body in abutment with one end of the elastic member.

12. The wrench as claimed in claim 7, wherein an outer circumference of a rear end of the tubular body is formed with a scale in adjacency to a front end of the handle.
